(19) United States
(12) Patent Application Publication
(10) Pub. No.: US 2004/0229690 A1
(43) Pub. Date: Nov. 18, 2004

(54) Video display systems

(76) Inventor: Dov L. Randall, Las Vegas, NV (US)

Correspondence Address: Bell, Boyd & Lloyd LLC, P.O. Box 1135, Chicago, IL, 60690-1135, US

(21) Appl. No.: 10/784,524

(22) Filed: Feb. 23, 2004

Related U.S. Application Data
(63) Continuation of application No. PCT/GB02/03993, filed on Aug. 23, 2002.

(30) Foreign Application Priority Data
Aug. 24, 2001 (GB) 0120611.9

(51) Int. Cl. A63F 13/00

(52) U.S. Cl. 463/31

(57) ABSTRACT

A video monitor displays a video simulation of a coin-operated player-operable entertainment machine. The video simulation can be selected from a range of simulations of different machines using a player-operable selector and a menu. The video simulations are derived from an internet web server to which the monitor is connected. The player can play a game with the selected video-simulated machine after providing game-playing credit. The machine may have symbol-bearing reels which display rotating symbol sequences and come to rest to display a combination of selected symbols which, if a winning combination, results in a pay-out. The symbols may be selected from greater numbers of symbols that are contained in the rotating sequences. Also compensation may be used to maintain the pay-out percentage within a desired range. Usage of individual machines may be monitored to assess, for example, commercial viability.

### PRIORITY CLAIM

This application is a continuation of International Application No. PCT/GB02/03993, filed on Aug. 23, 2002, entitled “VIDEO DISPLAY SYSTEMS”, which is incorporated herein in its entirety.

### COPYRIGHT NOTICE

A portion of the disclosure of this patent document contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### DESCRIPTION

The present invention relates to video display systems, particularly for displaying video simulation of player-operable entertainment machines.

### BACKGROUND OF THE INVENTION

Multiple player-operable entertainment machines may be provided in arcades or other entertainment premises. These machines may include coin-operated amusement-with-prizes (AWP) machines, such as ‘fruit’ or ‘poker’ machines of the kind having a main display device for displaying a selected combination of symbol at a win zone. As used herein the term “coin” is intended also to cover tokens, charge or credit cards or any other means of supplying credit or monetary value.

In the same arcade it is usual for there to be several different kinds of machines so that a player can select a preferred kind of machine and also so that players can try different machines in the hope that this may improve their chances of winning. This adds to player enjoyment.

It is also usual for new or prototype machines to be placed in an arcade prior to widespread distribution to assess their popularity and commercial viability.

It is known to provide a video simulation of a player-operable entertainment machine on the internet. However, this can lack the entertainment value of playing an actual machine, particularly compared with the playing of machines in arcades.

One object of the present invention is to provide enhanced player entertainment in the context of a video simulation of a player-operable machine.

### SUMMARY OF THE INVENTION

In one embodiment of the present invention, a video monitor displays a video simulation of a coin-operated player-operable entertainment machine. In one embodiment, the video simulation can be selected from a range of simulations of different machines using a player-operable selector and a menu. In another embodiment, the video simulations are derived from an internet web server to which the video monitor is connected. The player can play a game with the selected video-simulated machine after providing game-playing credit. In one embodiment, the machine may have symbol-bearing reels which display rotating symbol sequences and come to rest to display a combination of selected symbols which, if a winning combination, results in a pay-out. In another embodiment, the symbols may be selected from greater numbers of symbols that are contained in the rotating sequences. In another embodiment, compensation may be used to maintain the pay-out percentage within a desired range. In an alternative embodiment, usage of individual machines may be monitored to assess, for example, commercial viability.

### BRIEF DESCRIPTION OF THE DRAWINGS

FIG. 1 is a schematic diagram of one embodiment of the video display apparatus of the present invention.

FIGS. 2 and 3 are front elevational views of one embodiment of the display of a terminal of the apparatus of FIG. 1.

### DETAILED DESCRIPTION OF THE INVENTION

According to one aspect of the invention, there is provided a video display apparatus operable to produce a video simulation of a player-operable entertainment machine. The video display apparatus includes control means for operation by a player to cause a game to be played With the video-simulated machine, wherein the video simulation is selectable from a plurality of video simulations respectively of different player-operable entertainment machines. In one embodiment, the video display apparatus also includes selector means for operation by the player for effecting selection.

In this embodiment, the player can switch from machine to machine, generally in like manner to an arcade of actual machines, thereby providing enhanced enjoyment.

In one embodiment, it is visualized that the present invention will find particular application in the context of the internet whereby the video display apparatus comprises a web server providing data in HTML or other code capable of producing the visual simulation on a connected PC or terminal monitor with a web browser. However, the invention is not restricted to this arrangement and the apparatus may comprise a local network or even a dedicated PC or the like.

With regard to the simulated entertainment machines at least some of these may be coin-operated ‘fruit’ machines as mentioned above. Thus, in one embodiment, the video simulation may comprise at least one front panel of a coin operated entertainment machine, and preferably there are upper and lower front panels.

In one embodiment, these fruit machines may be of the ‘real’ kind, in which the main display device comprises multiple symbol bearing side-by-side reels which are rotatable, preferably about a common horizontal axis within a housing, behind a window at a win zone. The reels may be actual or video simulated. Each reel may have symbols at equally spaced positions around its periphery whereby the reels can be brought to rest with one or more symbols on each reel display through the window on a win line or win lines. If the displayed combination of symbols constitutes a predetermined winning combination an award may be made available to the player.

In another embodiment, the fruit machines may be of the kind having a supplementary display or ‘feature game’, particularly a trail-based feature game, which can be used to enhance the entertainment value of the machine and provide additional or alternative opportunities for winning. Such feature game may be provided by a panel having sections which can be selectively illuminated to represent movement from location to location, such as along a trail or a wraparound trail, which may simulate the playing of a board game.

In one embodiment, play may be transferred from the main reels to the supplementary feature game on a random or predetermined basis and illumination of the panel sections may then be effected by, or in correspondence with, a rotatable subsidiary feature reel, or otherwise, representing the spin of a reel or roll of a dice or other selection. Awards or award possibilities may be made available to the player in dependence on the location on the trail to which play has progressed.

In one alternative embodiment, these fruit machines may have other known features, such as ‘nudge’, ‘hold’, ‘gamble’. In these embodiment, there may be provisions for the player to operate machine controls such as start, hold, nudge, gamble, payout buttons. In another embodiment, the simulated entertainment machines may include kinds of entertainment machines other than fruit machines.

In one embodiment of the present invention, the video simulation of the entertainment machine may be such as to present to the player a closely detailed representation of an actual machine including lettering and artwork as appropriate with component parts of the machine shown in their correct relative position and movable or changeable parts moving or changing visually in like manner to the real machine.

The player may have the opportunity of playing the video simulations of the entertainment machine in like manner to the actual machine. In particular there may be a credit means operable to provide credit whereby the game is playable after provision of a predetermined game-playing credit value, and award means operable to make available a payout following a winning outcome of a game. Thus, there may be provision of or insertion of credit, which may be simulated monetary value, which may be entered by the player or which may be automatically entered at the start of a playing session. In another embodiment, the insertion of credit may be real monetary value entered by the player, such as by means of credit card (i.e., by player entry of credit card data) or by charge to an existing player account or otherwise.

In one embodiment, wins within a game may be rewarded with extra features, such as nudge steps or with points scored, and a winning outcome to a game may result in a notional monetary payout or as a real payout credited to the player. In another embodiment, the machine simulation may include the usual meters showing, for example, game-play credit and wins.

The arrangement may be such that only one machine is displayed at a time, or alternatively multiple machines may be displayed. Selection of machines may be achieved in any suitable manner preferably such that the selector means is operable for selection from a displayed menu of the video simulations. On switching from one selected machine to another, credit may be transferred to the new machine automatically or as selected by the player, partially or completely. Entry of data and operation of controls may be achieved by use of a computer keyboard or a mouse which can be clicked on displayed buttons (i.e., by mouse click on a menu of game names) or otherwise.

In one embodiment, the payout of an actual fruit machine may be on a wholly random basis. That is, the stopping position of the reels may be determined by software generated random numbers. If this is related to the number of symbols on each reel (typically 24) the likelihood of obtaining any particular combination (e.g. a one-off jackpot combination) would be the product of the numbers of symbols (e.g. 24×24×24 for a three reel machine).

In another embodiment, in order to have a reduced likelihood, and hence a possibly larger jackpot pay-out, the present invention increases the ‘virtual’ number of symbols for each reel so that the random selection for each reel is from a series of symbols greater in number than the stopping position of the reel. Thus, for example, a 24 stopping position reel may use a series of say 30 symbols whereby the likelihood of the reel stopping on a single jackpot symbol is 1:30 not 1:24. In this embodiment, each reel has a predetermined plurality of symbols which are displayed in sequence during rotation of the reel and the reel then comes to rest to display one or more selected symbols on a win line or win lines in the win zone, wherein the symbol is selected from a plurality of symbols which is greater than the predetermined plurality.

In another embodiment, the present invention uses a pseudo-random arrangement with a compensator which operates to maintain pay-outs as close as possible to a desired percentage (e.g. say 80% of game-play credit Is returned as prizes). With this arrangement, after each play a win counter is incremented or decremented depending on the game outcome. When the counter is deemed to be outside an acceptable range (i.e., due to too many or too few wins) the outcome of games is influenced to return the counter to the acceptable range. In alternative embodiments, this may involve rejection and reselection of generated random numbers, deliberate selection of specific outcomes such as jackpots, nudge features, feature game transfers or otherwise. Thus, in one embodiment, there is provided a compensator which monitors the percentage of game-play credit which is paid out as winnings, the compensator being operable to influence the outcome of games to maintain the percentage within a predetermined range.

By use of win pay-out percentage compensation and/or virtual increase in reel stopping positions as described above play of the simulated entertainment machines can represent closely play of actual machines thereby enhancing player enjoyment.

In another embodiment of the present invention, the video display apparatus is operable to produce, via a network, such as the internet, a video simulation of an entertainment machine of the symbol-bearing rotatable reel coin-operated kind. In this embodiment, the likelihood of obtaining a win is influenced by virtual increase in reel stopping positions such that each reel has a predetermined plurality of symbols which are displayed in sequence during rotation of the reel. The reels come to rest to display one or more selected symbols on a win line or win lines in the win zone, wherein the symbol is selected from a plurality of symbols which is greater than the predetermined plurality.

In another embodiment of the present invention, the video display apparatus is operable to produce, via a network, such as the internet, a video simulation of an entertainment machine of the symbol-bearing rotatable reel coin-operated kind. In this embodiment, likelihood of obtaining a win is influenced by win pay-out percentage compensation whereby there is provided a compensator which monitors the percentage of game-play credit which is paid out as winnings. That is, the compensator is operable to influence the outcome of games to maintain the percentage within a predetermined range.

In another embodiment, the video display apparatus of the present invention may be used for assessment and evaluation of machines whereby a monitoring device may be linked to a particular machine to monitor parameters such as frequency and duration of use, number of plays in a session, credit token and paid out. That is, there may be provided a monitoring device operable to monitor at least one parameter of player operation of at least one said video-simulated machine. In this embodiment, this information may relate solely to the monitored machine or may be collected for a number of machines so that a relative assessment and evaluation can be effected. The resulting information may be made available only to an authorized person and not to players by relaying information to a separate control location not accessible to the player and/or by providing on-line access to data via a password protected interface.

Thus, in another embodiment of the present invention, the video display apparatus is operable to produce via a network, such as the internet, a video simulation of an entertainment machine, such as a machine of the symbol bearing rotatable reel coin-operated kind. This embodiment includes a monitoring device for assessment and evaluation of usage of the machine.

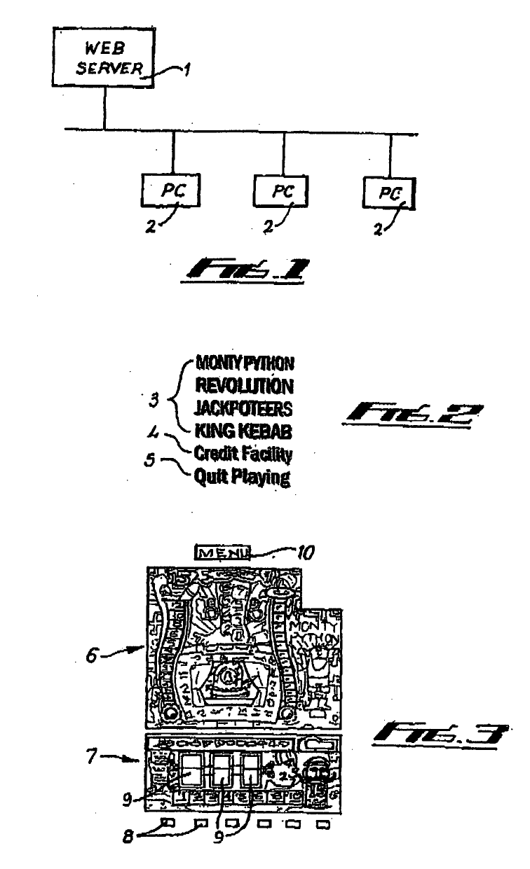

As shown in FIG. 1, an internet-based virtual arcade has a server 1 which is accessible from a plurality of PCs 2. In one embodiment, the PCs 2 access the server 1 by using web browsers in the PCs 2 and HTML or other web browser coding at the addressed location of the server 1.

As seen in FIG. 2, upon accessing the appropriate web site, a user is presented with an initial menu which relates to a number of machines 3 available in the virtual arcade.

The menu also includes a credit facility option 4 and a quit option 5. On selecting the credit facility option, such as by a ‘mouse over’ and ‘mouse click’, the player is presented with a secure form-based section for adding monetary credit to the player's account, such as by entry of credit card details. The player can then return to the menu and select one of the machines 3.

Upon selecting one of the machines 3, as seen in FIG. 3, the player's PC 2 produces a detailed representation of the top and bottom panels 7 of a reel-type fruit machine including artwork, lettering, movable and changeable components, such as reels, back illuminated ladders and trails, LED meters and counters. Moreover, beneath the panels 6, 7, are the player controls 8, such as push buttons.

The player can now play the machine by pressing the buttons 8, (e.g., to start, nudge, hold, pay-out) with a mouse click on the displayed buttons. The machine then operates in the usual way, such as by spinning the reels 9, moving the back-illumination or otherwise. In one embodiment, symbol combinations are selected. In this embodiment, if wins are awarded, the player can attain a pay-out by mouse clicking the pay-out button 8. Awards paid out may be credited to the player's account.

It should be appreciated that in this embodiment, the course of play is determined in exactly the same way as an actual machine and this may use random number generation modified by virtual increase in reel stopping position and/or percentage pay-out monitoring and compensation.

The screen also has a mouse clickable option 10 to return to the main menu whereby the player can add more credit to his account, arrange for refund of credit, quit, or switch to a different machine. On switching to a different machine credit may be transferred to that machine. In one embodiment, the screen option to return to the main menu may only be available at the end of a game and provision may be made for evaluating and remembering current credit in the event that access to the web site or to a machine is terminated prematurely.

In one embodiment, each machine is associated with monitoring software at the server 1 which assesses and evaluates play. In this embodiment, parameters such as operational characteristics (i.e. whether the machine functions as intended), and popularity characteristics (i.e. frequency and duration of play), and in particular commercial characteristics (i.e. monetary value taken over a period of time), are monitored. The resulting data can be accessed on the server, such as from a control PC using password protected access. This data can be used to determine whether the machine should be distributed as an actual machine.

With the virtual arcade described above, player enjoyment is much enhanced and valuable information relating to commercial viability of new machine ideas can be obtained.

It is of course to be understood that the invention is not intended to be restricted to the details of the above embodiment which are described by way of example only. That is, while the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A video display apparatus comprising:
means for enabling a player to select one of a plurality of video simulations, wherein each video simulation is based on a different player-operable entertainment machine;
means to produce said selected video simulation of a player-operable entertainment machine; and
means for enabling the player to cause a game to be played with the selected video-simulation.

2. The video display apparatus of claim 1, which includes an internet web server operable to produce said video simulation on a web browser connected to a monitor.

3. The video display apparatus of claim 1, which includes enabling the player to select one of the video simulations from a display menu.

4. The video display apparatus of claim 1, wherein the produced video simulation includes displaying at least one front panel of a coin-operated entertainment machine.

5. The video display apparatus of claim 4, wherein the produced video simulation includes displaying an upper front panel and a lower front panel.

6. The video display apparatus of claim 4, wherein the produced video simulation includes displaying a trail-based feature game on the front panel.

7. The video display apparatus of claim 4, wherein the produced video simulation includes displaying a main display device which includes a plurality of symbol-bearing side-by-side reels that are each rotatable behind a window in the front panel.

8. The video display apparatus of claim 7, wherein each reel has a predetermined plurality of symbols which are displayed in sequence during rotation.

9. The video display apparatus of claim 8, wherein when each reel stops rotating, at least one selected symbol is displayed on at least one win line, wherein the displayed symbol is selected from a plurality of symbols which is greater than said predetermined plurality.

10. The video display apparatus of claim 1, which includes means to enable the player to input an amount of game play credit, wherein said game is playable when a predetermined amount of game play credit is inputted.

11. The video display apparatus of claim 10, wherein the inputted amount of game play credit is transferable between said video simulations of different player operable entertainment machines.

12. The video display apparatus of claim 1, which includes means to provide the player an award following a winning outcome in said played game.

13. The video display apparatus of claim 12, which includes a compensator operable to: monitor the provided awards, determine a percentage of inputted game play credits which are provided as awards to the player and influence the outcome of said played games to maintain the percentage within a predetermined range.

14. The video display apparatus of claim 1, which includes a monitoring device operable to monitor at least one parameter of player operation of at least one of said games played.

15. A video display apparatus operable over a network, said video display apparatus comprising:
means to produce a video simulation of a symbol bearing rotatable reel entertainment machine, wherein each simulated reel has a predetermined plurality of symbols;
means for enabling a player to cause a game to be played and displayed on said video simulation, wherein said game includes sequentially displaying the plurality of symbols on the reels during at least one rotation of the reels; and
means to provide an outcome in said game based on at least one selected symbol on at least one win line wherein the symbol is selected from a plurality of symbols which is greater than said predetermined plurality of symbols.

16. The video display apparatus of claim 15, wherein said network is an internet.

17. A video display apparatus operable over a network, said video display apparatus comprising:
means to produce a video simulation of a symbol bearing rotatable reel entertainment machine;
means to enable a player to input an amount of game play credit, wherein at least one game play is displayed on said video simulation when a predetermined amount of game play credit is inputted;
means to provide the player an award following a winning outcome in said played game; and
a compensator operable to: monitor the provided awards, determine a percentage of inputted game play credits which are provided as awards to the player and influence the outcome of said played games to maintain the percentage within a predetermined range.

18. The video display apparatus of claim 17, wherein said network is an internet.

19. A video display apparatus operable over a network, said video display apparatus comprising:
means to produce a video simulation of a symbol bearing rotatable reel entertainment machine;
means for enabling a player to cause a game to be played and displayed on said video simulation; and
a monitoring device operable to assess and evaluate the usage of the machine.

20. The video display apparatus of claim 19, wherein said network is an internet.
